(19) United States
(12) Patent Application Publication
(10) Pub. No.: US 2012/0032921 A1
(43) Pub. Date: Feb. 9, 2012

(54) OPTICAL TOUCH SYSTEM

(75) Inventors: Ping-Chung Lin, Taipei City (TW); Chen-Kuan Lin, Fengyuan City (TW); Yu-Chen Chen, Xindian City (TW); Yi-Chien Lin, Taipei City (TW)

(73) Assignee: Quanta Computer Inc., Tao Yuan Shien (TW)

(21) Appl. No.: 12/954,044

(22) Filed: Nov. 24, 2010

(30) Foreign Application Priority Data
Aug. 6, 2010 (TW) 99126383

(51) Int. Cl. G06F 3/042

(52) U.S. Cl. 345/175

(57) ABSTRACT

An optical touch system includes a first light source, a second light source, a sensing module and a processing module. The lighting timing of the second light source differs with the lighting timing of the first light source by a phase. The sensing module is for capturing a sensing image related to a touch point on a panel, and receiving a first bounce light of the touch point corresponding to the first light source and a second bounce light of the touch point corresponding to the second light source. The processing module is for obtaining angle information according to the sensing image, calculating a phase difference between the first bounce light and the second bounce light to obtain distance information, and determining a coordinate corresponding to the touch point according to the angle information and the distance information.

This application claims the benefit of Taiwan application Serial No. 99126383, filed Aug. 6, 2010, the subject matter of which is incorporated herein by reference.

### BACKGROUND OF THE INVENTION

1. Field of the Invention

The invention relates in general to an optical touch system, and more particularly to an optical touch system with high accuracy.

2. Description of the Related Art

The touch screen which provides an instinctive way of operation has now been widely used in various electronic products, such as portable electronic device, desktop computer or ATM. According to the principles of sensing, the touch screen can be divided into resistive touch screen, capacitive touch screen, ultra-sonic touch screen and optical touch screen. Let the optical touch screen be taken for example. When an object such as the user's finger or a stylus is placed in the touch region, the light emitted from the light source will be blocked by the object. Based on the image received by the sensor, the touch point coordinate of the object in the touch region can thus be obtained.

However, as the technology advances, the demand for multi-touch technology also grows. However, the conventional method for determining the touch point coordinate according to the image received by the sensor and the measured angle cannot meet the requirement of the multi-touch technology. Thus, how to increase the accuracy of determining the touch point coordinate has become an imminent task to the industry.

### SUMMARY OF THE INVENTION

The invention is directed to an optical touch system, which increases the accuracy of determining a touch point coordinate according to angle information and distance information between a touch point and a sensing module.

According to a first aspect of the present invention, an optical touch system including a first light source, a second light source, a sensing module and a processing module is provided. The lighting timing of the second light source differs with that of the first light source by a phase. The sensing module is for capturing a sensing image related to a touch point on a panel, and receiving a first bounce light of the touch point corresponding to the first light source and a second bounce light of the touch point corresponding to the second light source. The processing module is for obtaining an angle information according to the sensing image, calculating a phase difference between the first bounce light and the second bounce light to obtain a distance information, and determining a coordinate corresponding to the touch point according to the angle information and the distance information.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows an optical touch system according to a preferred embodiment of the invention;

FIG. 2 shows a first light source, a second light source and a sensing module according to a preferred embodiment of the invention; and

FIG. 3 shows a diagram of timing wave-patterns of a first light source, a second light source, a first sensor and a second sensor according to a preferred embodiment of the invention.

### DETAILED DESCRIPTION OF THE INVENTION

The invention provides an optical touch system, which increases the accuracy of determining a touch point coordinate according to the information of the angle at the touch point and the information of the distance from the touch point to the sensing module, wherein the angle information is obtained by the sensing module and the distance information is obtained from the calculation of the phase difference between different bounce lights.

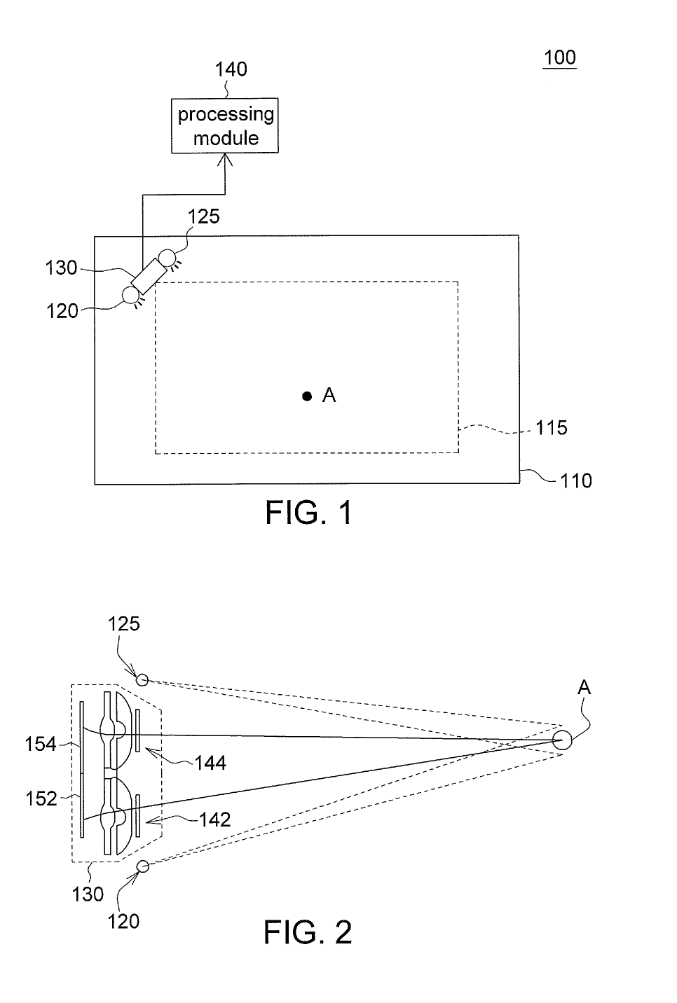

Referring to FIG. 1, an optical touch system according to a preferred embodiment of the invention is shown. The optical touch system 100 is for determining a touch point coordinate on a panel 110. A touch region 115 can be defined on the panel 110 by a number of optical elements such as light guide bars and reflectors. The optical touch system 100 includes a first light source 120, a second light source 125, a sensing module 130 and a processing module 140. The first light source 120 and the second light source 125 have the same lighting frequency (such as 100 MHz), but the lighting timing of the first light source 120 differs with that of the second light source 125 by a phase.

In the exemplification below, the lighting timing of the first light source 120 differs with that of the second light source 125 by 180 degrees, but such exemplification is not for limiting the invention. Referring to FIG. 2, a first light source 120, a second light source 125 and a sensing module 130 according to a preferred embodiment of the invention is shown. In FIG. 2, the first light source 120 such as emits a P polarized light, and the second light source 125 such as emits an S polarized light, wherein the P polarized light and the S polarized light are two polarized light components perpendicular to each other. The sensing module 130 includes a first filter 142, a second filter 144, a first sensor 152 and a second sensor 154. The first filter 142 is for receiving a reflected P polarized light (the first bounce light), and the second filter 144 is for receiving a reflected S polarized light (the second bounce light). The above effect can be achieved by using light sources of different wavelengths accompanied by a band-pass filter.

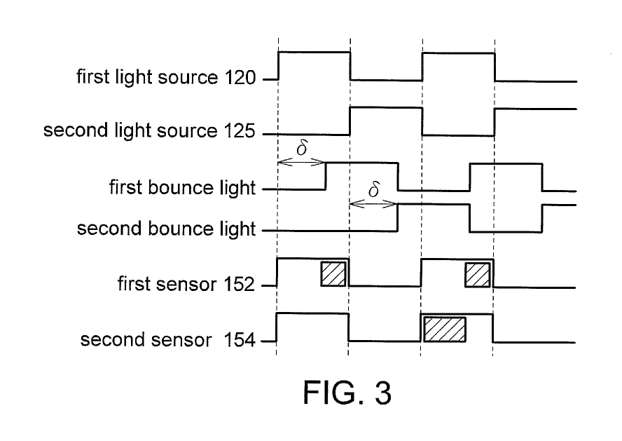

The sensing module 130 captures a sensing image related to a touch point A on a panel 110. The processing module 140 obtains an angle information corresponding to touch point A according to the sensing image. Referring to FIG. 3, a diagram of timing wave-patterns of the first light source 120, the second light source 125, the first sensor 152 and the second sensor 154 according to a preferred embodiment of the invention is shown. As indicated in FIG. 3, the first sensor 152 and the second sensor 154 perform exposure at a fixed frequency (such as 100 MHz), so that the control burden of the entire optical touch system is reduced.

After the light emitted from the first light source 120 is reflected through the touch point A, the first bounce light returns in a time difference 6. Then, the first bounce light is received by a lens assembly of the sensing module 130 and then focused on the first sensor 152, which accordingly analyzes the strength of the first bounce light. After the light emitted from the second light source 125 is reflected through touch point A, the second bounce light also returns in the same time difference 6. Then, the second bounce light is received by a lens assembly of the sensing module 130 and then focused on the second sensor 154, which accordingly analyzes the strength of the second bounce light.

The processing module 140 calculates the ratio of the strength of the first bounce light to the strength of the second bounce light to obtain the phase difference between the first bounce light and the second bounce light. For example, let the lighting frequency (such as 100 MHz) of the first light source 120 be the same with that of the second light source 125, but the lighting timing of the first light source 120 differs with that of the second light source 125 by 180 degrees. Suppose the ratio of the strength of the first bounce light to the strength of the second bounce light is 8.333:1.667, the processing module 140 calculates the phase difference between the first bounce light and the second bounce light as: 1.667/(8.333+1.667)×10⁻⁸=1.667×10⁻⁹. The processing module 140 can further multiplies the phase difference 1.667×10⁻⁹ with the light speed to obtain a proceeding optical path of 50 cm. In other words, the information of the distance from the touch point A to the sensing module 130 is a half of the optical path and equal to 25 cm.

After the angle information and the distance information are obtained, the processing module 140 combines the angle information and the distance information to accurately determine a coordinate corresponding to the touch point A.

Since the aberration of the optical lens results in optical distortion to the relation between view angle and image height, the optical touch system 100 of the present embodiment of the invention can apply image processing to the images formed on the first sensor 152 and the second sensor 154 so as to calibrate the error caused by optical distortion. Furthermore, phase difference occurs between the images formed on the first sensor 152 and the second sensor 154 due to the difference in optical paths. The phase difference is caused by the errors occurring during the manufacturing and the assembly of the elements. The optical touch system 100 can dispose a reflective plate at a suitable distance, and compare the measured phase difference to the theoretical phase difference to obtain a base error on which system calibration is based.

The optical touch system disclosed in the above embodiments of the invention has many advantages exemplified below:

The optical touch system of the invention increases the accuracy of determining a touch point coordinate according to the angle information of the touch point and the information distance from the touch point to the sensing module, wherein the angle information is obtained by the sensing module and the distance information is obtained from the calculation of the phase difference between different bounce lights. The optical touch system of the invention has high accuracy, and meets the requirement of the multi-touch technology.

While the invention has been described by way of example and in terms of the preferred embodiment (s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An optical touch system, comprising:
a first light source;
a second light source, wherein the lighting timing of the second light source differs with that of the first light source by a phase;
a sensing module for capturing a sensing image related to a touch point on a panel, and receiving a first bounce light of the touch point corresponding to the first light source and a second bounce light of the touch point corresponding to the second light source; and
a processing module for obtaining an angle information according to the sensing image, calculating a phase difference between the first bounce light and the second bounce light to obtain a distance information, and determining a coordinate corresponding to the touch point according to the angle information and the distance information.

2. The optical touch system according to claim 1, wherein the lighting timing of the second light source differs with the lighting timing of the first light source by 180 degrees.

3. The optical touch system according to claim 1, wherein the first light source emits a P polarized light, the second light source emits an S polarized light, and the sensing module at least comprises a first filter for receiving the reflected P polarized light and a second filter for receiving the reflected S polarized light.

4. The optical touch system according to claim 1, wherein the sensing module at least comprises a first sensor for analyzing the strength of the first bounce light and a second sensor is for analyzing the strength of the second bounce light, and the processing module calculates the ratio of the strength of the first bounce light to the strength of the second bounce light to obtain the phase difference between the first bounce light and the second bounce light.
